(19) United States
(12) Patent Application Publication
(10) Pub. No.: US 2004/0044089 A1
(43) Pub. Date: Mar. 4, 2004

(54) Defoamer for concrete admixtures

(75) Inventors: Donald R. Lane, Richfield, OH (US); Jose A. Melendez, North Canton, OH (US)

Correspondence Address: James A. Hudak, Esq., Suite #304, 29425 Chagrin Blvd., Cleveland, OH, 44122-4602, US

(73) Assignee: Tomahawk, Inc.

(21) Appl. No.: 10/228,380

(22) Filed: Aug. 27, 2002

(51) Int. Cl. B01D 21/01

(52) U.S. Cl. 516/113

(57) ABSTRACT

The present invention is directed to a defoaming agent for use with polycarboxylate based admixtures for concrete. The defoaming agent is comprised of tributyl phosphate, an alkylaryl sulfonic acid metallic salt and a modified alkylpolyalcoxyester. Tributyl phosphate is a phosphate ester based defoamer and the modified alkylpolyalcoxyester is an air detraining agent. The alkylaryl sulfonic acid metallic salt is used as a hydrotrope to ensure that the tributyl phosphate and the modified alkylpolyalcoxyester react and do not separate.

### TECHNICAL FIELD

The present invention relates, in general, to a defoaming agent for concrete admixtures and, more particularly, to a defoamer for use with polycarboxylate based admixtures for concrete.

### BACKGROUND ART

Polycarboxylate based admixtures are highly effective superplasticizers for concrete. Such admixtures significantly reduce the amount of water required in the concrete. The use of polycarboxylate based admixtures, however, creates an inherent problem in that they generate a significant amount of air, and thus, require the use of a defoaming agent. It has been found that such defoaming agents cause the resulting admixture to become very viscous and separation of the components therein can occur. Thus, the defoaming agents that are presently available for use with polycarboxylate based admixtures do not produce acceptable results.

As for other superplasticizing admixtures for concrete, napthalene formaldehyde condensate or melamine formaldehyde condensate are typically used. The use of such superplasiticizers typically results in a reduction in the amount of water required in the concrete and an increase in the overall strength of same. Rather large dosages of these superplasticizers are typically required in order to accomplish water reduction, however, if the dosage is increased, the rate of set of the concrete is retarded. It has been found that if polycarboxylate material is used as the superplasticizer, the amount of water reduction and increase in concrete strength is greater than if napthalene formaldehyde condensate or melamine formaldehyde condensate is used. In addition, if polycarboxylate material is used as the superplasticizer, the dosage required as compared to the dosage required of napthalene formaldehyde condensate or melamine formaldehyde condensate is less. Furthermore, if polycarboxylate material is used as the superplasticizer and the dosage of same is increased, the amount of water reduction in the concrete is further increased and the rate of set of the concrete is not affected.

In view of the foregoing, it has become desirable to develop a defoaming agent for polycarboxylate based admixtures in which the components do not separate and in which the viscosity of the resulting combination is maintained.

### SUMMARY OF THE INVENTION

The present invention solves the problems associated with defoaming agents presently available for polycarboxylate based admixtures for concrete by providing a defoaming agent comprising tributyl phosphate, an alkylaryl sulfonic acid metallic salt and a modified alkylpolyalcoxyester. Tributyl phosphate is a phosphate ester based defoamer and the modified alkylpolyalcoxyester is an air detraining agent. The alkylaryl sulfonic acid metallic salt is a hydrotrope that ensures that the tributyl phosphate and the modified alkylpolyalcoxyester react and do not separate. When up to 7% of the aforementioned defoaming agent is added to a polycarboxylate based admixture, the resulting air content with a normal dosage of an air entraining agent in the concrete meets ASTM specifications.

### DESCRIPTION OF THE PREFERRED EMBODIMENT

The present invention overcomes the problems associated with the use of those superplasticizing admixtures for concrete that have a significant capacity for generating air. One of the most highly effective superplasticizers is a polycarboxylate based admixture. It has been found that polycarboxylate based admixtures significantly reduce the amount of water required in the concrete, however, they also generate a significant amount of air, thus requiring the use of a defoaming agent. Such defoaming agents typically cause the resulting combination to become very viscous and separation into the individual components can occur. The defoaming agent of the present invention overcomes these problems and is comprised of the following:

| Tributyl Phosphate | 30 to 70% | (By weight) |
|---|---|---|
| Alkylaryl Sulfonic Acid Metallic Salt | 0.5 to 5% | |
| Modified Alkylpolyalcoxyester | 30 to 70% | |
| | 100% | |

In this case, the alkylaryl sulfonic acid metallic salt is used as a hydrotrope to ensure that the tributyl phosphate and the modified alkylpolyalcoxyester react and do not separate. It has been found that when up to 7% of the foregoing defoaming agent is added to a polycarboxylate based admixture, the amount of air generated in the concrete is significantly reduced and the concrete containing the aforementioned admixture meets ASTM specifications of 5-7% air content. A higher air content in the concrete significantly reduces the strength of same.

In essence, the present invention is a water soluble defoaming agent that can be used to control the air entraining properties in polycarboxylate based admixtures which are used as superplasticizers in concrete. In this case, tributyl phosphate is a phosphate ester based defoamer but is not water soluble. Tributyl phosphate is blended with the modified alkylpolyalcoxyester which is another ester and which has extremely good air detraining properties. The alkylaryl sulfonic acid metallic salt is added to the tributyl phosphate and the modified alkylpolyalcoxyester and acts as a cross-linking coupling agent. In essence, the alkylaryl sulfonic acid metallic salt cross-links the phosphate portion of the tributyl phosphate with the double bond in the carbonyl group in the modified alkylpolyalcoxyester by means of a co-valent electronic bond, making the non-polar ends polar, and thus, making the resulting combination water soluble. The use of an alkylaryl sulfonic acid metallic salt as a hydrotrope produces a single phase stable formulation in the non-soluble composition. In essence, the hydrotrope prevents the liquid products from separating into layers, thus ensuring homogeneity. In addition, its ionic nature causes the resulting polarity of the new composition to be such that the new composition is water soluble. Water is a polar substance and thus, is considered to be the “universal solvent”. When a hydrotrope is used, non-polar molecules become polar and the resulting composition becomes water soluble.

The composition of the present invention lowers the surface tension of the polycarboxylate based admixture causing the resulting solution to hold significantly less air. Thus, the amount of air generated by the use of polycarboxylate based admixtures is significantly reduced resulting in the formation of less foam.

With respect to other superplasticizing admixtures, napthalene formaldehyde condensate or melamine formaldehyde condensate are typically used. Such superplasticizers typically result in a water reduction of 12-25% in concrete and a 150% increase in the overall strength of the concrete. These superplasticizers typically require dosages of 10-32 ounces per one hundred pounds of cement. However, as more napathalene formaldehyde condensate or melamine formaldehyde condensate is used, the rate of set of the concrete is retarded. In contrast, if a superplasticizer such as a polycarboxylate based admixture is utilized, the water reduction is 15-40%, the resulting strength increase in the concrete is 200% and a dosage of only 2-8 ounces per one hundred pounds of cement is required. In addition, if a polycarboxylate based admixture is utilized and the dosage of same is increased, water reduction is further increased and the rate of set is not affected. The present invention overcomes the inherent problem of air generation and foaming associated with polycarboxylate based admixtures, and thus, permits polycarboxylate based admixtures to be readily utilized to obtain the benefits of water reduction, an increase in the strength of the concrete and the use of lower dosages when compared with other types of superplasticizers.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A defoaming agent for use with concrete admixtures comprising tributyl phosphate, an alkylaryl sulfonic acid metallic salt and a modified alkylpolyalcoxyester.

2) The defoaming agent as defined in claim 1 wherein said tributyl phosphate amounts to about 30 to 70% by weight of said defoaming agent.

3) The defoaming agent as defined in claim 1 wherein said alkylaryl sulfonic acid metallic salt amounts to about 0.5 to 5% by weight of said defoaming agent.

4) The defoaming agent as defined in claim 1 wherein said modified alkylpolyalcoxyester amounts to about 30 to 70% by weight of said defoaming agent.
